(19) United States
(12) Patent Application Publication
(10) Pub. No.: US 2011/0164156 A1
(43) Pub. Date: Jul. 7, 2011

(54) IMAGE PICKUP DEVICE AND SOLID-STATE IMAGE PICKUP ELEMENT

(76) Inventors: Masao Hiramoto, Osaka (JP); Khang Nguyen, Osaka (JP); Yusuke Monobe, Kyoto (JP); Seiji Nishiwaki, Hyogo (JP); Masaaki Suzuki, Osaka (JP)

(21) Appl. No.: 13/119,317

(22) PCT Filed: Jul. 21, 2010
(86) PCT No.: PCT/JP2010/004663

§ 371 Date: Mar. 16, 2011

(30) Foreign Application Priority Data
Jul. 24, 2009 (JP) 2009-172707

(51) Int. Cl. H04N 5/335

(52) U.S. Cl. 348/272; 348/294; 348/E05.091

(57) ABSTRACT

A solid-state image sensor according to the present invention includes: a semiconductor layer 7, which has a first surface and a second surface that is opposite to the first surface; a photosensitive cell array, which has been formed in the semiconductor layer 7 to receive light through both of the first and second surfaces; and at least one dispersive element array, which is arranged on the same side as at least one of the first and second surfaces so as to face the photosensitive cell array. The photosensitive cell array includes first and second photosensitive cells 2a and 2b. And the dispersive element array makes light rays falling within mutually different wavelength ranges incident on the first and second photosensitive cells 2a and 2b, respectively.

### TECHNICAL FIELD

The present invention relates to a technique for increasing the sensitivity of a solid-state image sensor and capturing color information using such a solid-state image sensor.

### BACKGROUND ART

Recently, the performance and functionality of digital cameras and digital movie cameras that use some solid-state image sensor such as a CCD and a CMOS (which will be simply referred to herein as an “image sensor”) have been enhanced to an astonishing degree. In particular, the size of a pixel structure for use in an image sensor has been further reduced these days thanks to rapid development of image capture device processing technologies, thus getting an even greater number of pixels and drivers integrated together in an image sensor. And the performance of image sensors has been further enhanced as well. Meanwhile, cameras that use a backside illumination type image sensor, which receives incoming light on its back surface side, not on its front surface side with a wiring layer for the solid-state image sensor, have been developed just recently and their high-sensitivity property has attracted a lot of attention these days. Nevertheless, the greater the number of pixels in an image sensor, the lower the intensity of the light falling on a single pixel and the lower the sensitivity of camera tends to be.

The sensitivity of cameras has dropped recently due to not only such a significant increase in resolution but also the use of a color-separating color filter itself. An ordinary color filter transmits one color component of incoming light but absorbs the other components of the light. That is why with such a color filter, the optical efficiency of a camera would decrease. Specifically, in a color camera that uses a Bayer color filter, for example, a subtractive color filter that uses an organic pigment as a dye is arranged over each photosensing section of an image sensor, and therefore, the optical efficiency achieved is rather low. In a Bayer color filter, color filters in three colors are arranged using a combination of one red (R) element, two green (G) elements and one blue (B) element as a fundamental unit. In this case, the R filter transmits an R ray but absorbs G and B rays, the G filter transmits a G ray but absorbs R and B rays, and the B filter transmits a B ray but absorbs R and G rays. That is to say, each color filter transmits only one of the three colors of R, G and B and absorbs the other two colors. Consequently, the light ray used by each color filter is only approximately one third of the light falling on that color filter.

To overcome such a decreased sensitivity problem, Patent Document No. 1 discloses a technique for increasing the intensity of the light received by attaching an array of micro lenses to a photodetector section of an image sensor. According to this technique, the incoming light is condensed with those micro lenses, thereby substantially increasing the optical aperture ratio. And this technique is now used in almost all solid-state image sensors. It is true that the aperture ratio can be increased substantially by this technique but the decrease in optical efficiency by color filters still persists.

Thus, to avoid the decrease in optical efficiency and the decrease in sensitivity at the same time, Patent Document No. 2 discloses an image sensor that has a structure for taking in as much incoming light as possible by using multilayer color filters (as dichroic mirrors) and micro lenses in combination. Such a device uses a combination of dichroic mirrors, each of which does not absorb light but selectively transmits only a component of light falling within a particular wavelength range and reflects the rest of the light falling within the other wavelength ranges. Each dichroic mirror selects only a required component of the light and makes it incident on its associated photosensing section and transmits the rest of the light. FIG. 8 is a cross-sectional view of the image sensor disclosed in Patent Document No. 2.

In the solid-state image sensor shown in FIG. 8, the light that has impinged on a condensing micro lens 3 has its luminous flux adjusted by an inner lens 4, and then enters a first dichroic mirror 13, which transmits a red (R) ray but reflects rays of the other colors. A second dichroic mirror 14 reflects a green (G) ray but transmits rays of the other colors. And a third dichroic mirror 15 reflects a blue (B) ray but transmits rays of the other colors. The light ray that has been transmitted through the first dichroic mirror 13 is then incident on a photosensitive cell 2 that is located right under the first dichroic mirror 13. On the other hand, the light ray that has been reflected from the first dichroic mirror 13 enters the second dichroic mirror 14 adjacent to the first dichroic mirror 13. The second dichroic mirror 14 reflects a green (G) ray and transmits a blue (B) ray. The green ray that has been reflected from the second dichroic mirror 14 is incident on a photosensitive cell 2 that is located right under the second dichroic mirror 14. On the other hand, the blue ray that has been transmitted through the second dichroic mirror 14 is reflected from the third dichroic mirror 15 and then incident on a photosensitive cell 2 that is located right under the dichroic mirror 15. In such a solid-state image sensor, the visible radiation that has impinged on the condensing micro lens 11 is not absorbed into color filters but their RGB components can be detected by the photosensitive cells non-wastefully.

Meanwhile, Patent Document No. 3 discloses an image sensor that can minimize the loss of light by using a micro prism. Such an image sensor has a structure in which the incoming light is split by the micro prism into red, green and blue rays to be received by three different photosensitive cells. Even when such an image sensor is used, the optical loss can also be minimized.

According to the techniques disclosed in Patent Documents Nos. 2 and 3, however, the number of photosensitive cells to provide needs to be as many as that of the dichroic mirrors to use or that of the color components to produce by splitting the incoming light. That is why to receive red, green and blue rays that have been split, for example, the number of photosensitive cells provided should be tripled compared to a situation where conventional color filters are used.

Furthermore, unlike any of those conventional techniques, Patent Document No. 4 discloses a technique for using light that has been incident on both sides of an image sensor. According to such a technique, optical systems and color filters are arranged so as to make visible radiation and non-visible radiation (such as an infrared ray or an ultraviolet ray) incident on the front surface of an image sensor, and its back surface, respectively. With such an arrangement, the image sensor can certainly obtain by itself an image that has been produced based on the visible radiation and an image that has been produced based on the non-visible radiation. Even so, such a technique does not contribute at all to increasing the optical efficiency that has been decreased by the color filters.

Furthermore, Patent Document No. 5 discloses a color representation technique for improving the optical efficiency without significantly increasing the number of photosensitive cells to use by providing micro prisms or any other appropriate structures as dispersive elements for those photosensitive cells. According to such a technique, each of the dispersive elements provided for the photosensitive cells splits the incoming light into multiple light rays and makes those light rays incident on the photosensitive cells according to their wavelength ranges. In this case, each of the photosensitive cells receives combined light rays, in which multiple components falling within mutually different wavelength ranges have been superposed one upon the other, from multiple dispersive elements. As a result, a color signal can be generated by making computations on the photoelectrically converted signals supplied from the respective photosensitive cells.

### CITATION LIST

### Patent Literature

Patent Document No. 1: Japanese Patent Application Laid-Open Publication No. 59-90467
Patent Document No. 2: Japanese Patent Application Laid-Open Publication No. 2000-151933
Patent Document No. 3: Japanese Patent Application Laid-Open Publication No. 2001-309395
Patent Document No. 4: Japanese Patent Application Laid-Open Publication No. 2008-072423
Patent Document No. 5: PCT International Application Publication No. 2009/153937

### SUMMARY OF INVENTION

### Technical Problem

To sum up, according to the conventional technologies, if light-absorbing color filters are used, the number of photosensitive cells to provide does not have to be increased significantly but the optical efficiency achieved will be low. Nevertheless, if color filters (or dichroic mirrors) or micro prisms that selectively transmit incoming light are used, then the optical efficiency will be high but the number of photosensitive cells to provide should be increased considerably.

Meanwhile, according to the technique disclosed in Patent Document No. 5, a color image can be certainly obtained with the optical efficiency improved, theoretically speaking. However, it should be very difficult to arrange structures such as micro prisms as densely as the image sensor's pixels.

It is therefore an object of the present invention to provide a color image capturing technique, by which the density of such light-splitting structures can be reduced and by which the light can be separated into respective color components even without increasing the number of photosensitive cells significantly.

### Solution to Problem

An image capture device according to the present invention includes a solid-state image sensor and an optical system for producing an image on an imaging area of the solid-state image sensor. The solid-state image sensor includes: a semiconductor layer, which has a first surface and a second surface that is opposite to the first surface; a photosensitive cell array, which has been formed in the semiconductor layer to receive light through both of the first and second surfaces; and at least one dispersive element array, which is arranged on the same side as at least one of the first and second surfaces so as to face the photosensitive cell array. The photosensitive cell array has a number of unit blocks, each of which includes first and second photosensitive cells, and the dispersive element array makes light rays falling within mutually different wavelength ranges incident on the first and second photosensitive cells.

In one preferred embodiment, the optical system makes one and the other halves of the light strike the first and second surfaces, respectively.

In another preferred embodiment, the at least one dispersive element array includes first and second dispersive element arrays, which are arranged on the same side as the first and second surfaces, respectively, so as to face the photosensitive cell array. The first dispersive element array makes a light ray falling within a first wavelength range incident on the first photosensitive cell and also makes light rays falling within the other non-first wavelength ranges incident on the second photosensitive cell. And the second dispersive element array makes a light ray falling within a second wavelength range, which is different from the first wavelength range, incident on the first photosensitive cell and also makes light rays falling within the other non-second wavelength ranges incident on the second photosensitive cell.

In this particular preferred embodiment, if incoming light is split into three light rays that represent first, second, third color components, the first dispersive element array includes a first dispersive element, which is arranged in association with the first photosensitive cell to make the light ray representing the first color component incident on the first photosensitive cell and also make both of the two light rays that represent the second and third color components incident on the second photosensitive cell. The second dispersive element array includes a second dispersive element, which is arranged in association with the second photosensitive cell to make the light ray representing the second color component incident on the first photosensitive cell and also make both of the two light rays that represent the first and third color components incident on the second photosensitive cell.

In an alternative preferred embodiment, if incoming light is split into three light rays that represent first, second and third color components, the first dispersive element array includes a first dispersive element, which is arranged in association with the first photosensitive cell to make the three light rays that represent the first, second and third color components incident on the first photosensitive cell, the second photosensitive cell, and one photosensitive cell included in a first adjacent unit block, respectively. The second dispersive element array includes a second dispersive element, which is arranged in association with the second photosensitive cell to make one and the other halves of the light ray representing the third color component incident on the first photosensitive cell and on one photosensitive cell included in a second adjacent unit block, respectively, and also make both of the two light rays that represent the first and second color components incident on the second photosensitive cell. The first photosensitive cell receives not only the light ray representing the first color component from the first dispersive element but also the light rays representing the third color component from the second dispersive element and from a dispersive element that is arranged in association with a photosensitive cell included in the first adjacent unit block. And the second photosensitive cell receives the light ray representing the second color component from the first dispersive element, the light ray representing the third color component from a dispersive element that is arranged in association with a photosensitive cell included in the second adjacent unit block, and the light rays representing the first and second color components from the second dispersive element.

In still another preferred embodiment, each unit block further includes third and fourth photosensitive cells. The first dispersive element array includes a third dispersive element, which is arranged in association with the third photosensitive cell to make the light ray representing the first color component incident on the third photosensitive cell and also make both of the two light rays that represent the second and third color components incident on the fourth photosensitive cell. The second dispersive element array includes a fourth dispersive element, which is arranged in association with the fourth photosensitive cell to make the light ray representing the second color component incident on the third photosensitive cell and also make both of the two light rays that represent the first and third color components incident on the fourth photosensitive cell.

In yet another preferred embodiment, each unit block further includes third and fourth photosensitive cells. The first dispersive element array includes a third dispersive element, which is arranged in association with the third photosensitive cell to make the three light rays that represent the first, third and second color components incident on the third photosensitive cell, the fourth photosensitive cell, and one photosensitive cell included in the second adjacent unit block, respectively. The second dispersive element array includes a fourth dispersive element, which is arranged in association with the fourth photosensitive cell of each unit block to make one and the other halves of the light ray representing the second color component incident on the third photosensitive cell and on one photosensitive cell included in the first adjacent unit block, respectively, and also make both of the two light rays that represent the first and third color components incident on the fourth photosensitive cell. The third photosensitive cell receives not only the light ray representing the first color component from the third dispersive element but also the light rays representing the second color component from the fourth dispersive element and from a dispersive element that is arranged in association with a photosensitive cell included in the second adjacent unit block. The fourth photosensitive cell receives the light ray falling within the third wavelength range from the third dispersive element, the light ray falling within the second wavelength range from a dispersive element that is arranged in association with a photosensitive cell included in the first adjacent unit block, and the two light rays falling within the first and third wavelength ranges from the fourth dispersive element, respectively.

In yet another preferred embodiment, the first, second, third and fourth photosensitive cells are arranged in columns and rows, the first photosensitive cell is adjacent to the second photosensitive cell, and the third photosensitive cell is adjacent to the fourth photosensitive cell.

In yet another preferred embodiment, the solid-state image sensor includes a first micro lens array, which is arranged to face the first dispersive element array and which includes multiple micro lenses, each of which condenses the incoming light toward the first and third dispersive elements, and a second micro lens array, which is arranged to face the second dispersive element array and which includes multiple micro lenses, each of which condenses the incoming light toward the second and fourth dispersive elements.

In yet another preferred embodiment, the image capture device further includes a signal processing section, which generates one color signal based on two photoelectrically converted signals supplied from the first and second photosensitive cells.

In this particular preferred embodiment, the signal processing section generates three color signals based on four photoelectrically converted signals supplied from the first, second, third and fourth photosensitive cells.

A solid-state image sensor according to the present invention includes: a semiconductor layer, which has a first surface and a second surface that is opposite to the first surface; a photosensitive cell array, which has been formed in the semiconductor layer to receive light through both of the first and second surfaces; and at least one dispersive element array, which is arranged on the same side as at least one of the first and second surfaces so as to face the photosensitive cell array. The photosensitive cell array has a number of unit blocks, each of which includes first and second photosensitive cells, and the dispersive element array makes light rays falling within mutually different wavelength ranges incident on the first and second photosensitive cells.

### Advantageous Effects of Invention

The solid-state image sensor and image capture device of the present invention have a photosensitive cell array that receives light on both of their front and back surface sides, and also uses a dispersive element array that does not absorb the light, thus achieving higher optical efficiency. Optionally, the dispersive element arrays may be arranged on both sides of the device. In that case, the density of dispersive elements to be arranged per side can be reduced, thus making the manufacturing process easier. What's more, signals representing three different color components can be obtained by arranging those dispersive elements appropriately.

### BRIEF DESCRIPTION OF DRAWINGS

FIG. 1 is a block diagram illustrating a basic arrangement for an image capture device according to the present invention.

FIG. 2A is a schematic representation illustrating the structure of an example of an image sensor according to the present invention.

FIG. 2B is a schematic representation illustrating another example of an image sensor according to the present invention.

FIG. 2C is a schematic representation illustrating still another example of an image sensor according to the present invention.

FIG. 3 is a block diagram illustrating an overall configuration for an image capture device as a first preferred embodiment of the present invention.

FIG. 4 schematically illustrates the arrangement of an optical system for the image capture device of the first preferred embodiment of the present invention.

FIG. 5A is a plan view illustrating an exemplary arrangement of pixels according to the first preferred embodiment of the present invention.

FIG. 5B is a plan view illustrating another exemplary arrangement of pixels according to the first preferred embodiment of the present invention.

FIG. 6A is a plan view illustrating the basic structure of an image sensor according to the first preferred embodiment of the present invention.

FIG. 6B is a cross-sectional view of the image sensor shown in FIG. 6A as viewed on the planes A-A′.

FIG. 6C is a cross-sectional view of the image sensor shown in FIG. 6A as viewed on the planes B-B′.

FIG. 7A is a plan view illustrating the basic structure of an image sensor according to a second preferred embodiment of the present invention.

FIG. 7B is a cross-sectional view of the image sensor shown in FIG. 7A as viewed on the planes C-C′.

FIG. 7C is a cross-sectional view of the image sensor shown in FIG. 7A as viewed on the planes D-D′.

FIG. 8 is a cross-sectional view of a conventional solid-state image sensor that uses micro lenses and multilayer color filters (or dichroic mirrors).

### DESCRIPTION OF EMBODIMENTS

First of all, the fundamental principle of the present invention will be described before its preferred embodiments are described. In the following description, to spatially split incident light into multiple components of light falling within mutually different wavelength ranges or having respectively different color components will be referred to herein as “splitting of light”. Also, in the following description, if “two light rays fall within mutually different wavelength ranges”, then it means that the major color components included in those two light rays are different from each other. For example, if one light ray is a magenta (Mg) ray and the other is a red (R) ray, the major color components of the magenta ray are red (R) and blue (B), which are different from the major color component red (R) of the red ray. Consequently, the magenta and red rays should fall within mutually different wavelength ranges.

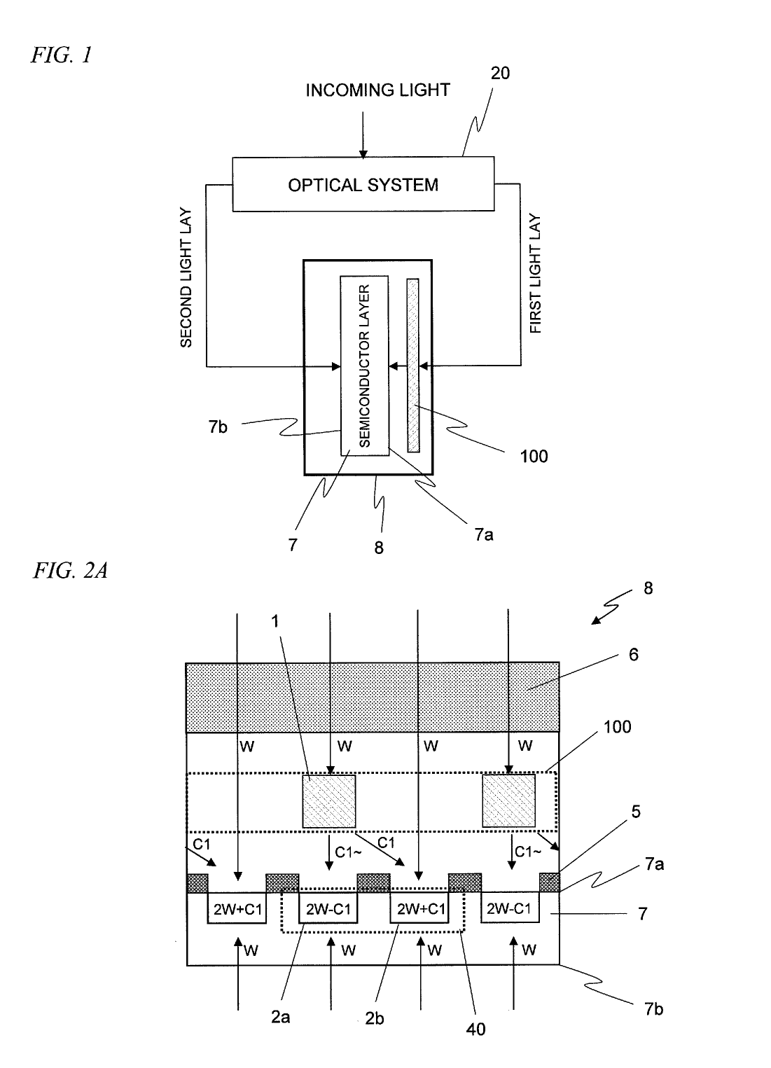

FIG. 1 is a block diagram illustrating a basic arrangement for an image capture device according to the present invention. The image capture device of the present invention includes an optical system 20 for imaging a given subject and a solid-state image sensor 8. Specifically, the solid-state image sensor 8 has a semiconductor layer 7 and can receive incoming light both at a first surface 7a of the semiconductor layer 7 and at its second surface 7b opposite to the first surface 7a. Between the first and second surfaces 7a and 7b, arranged is a two-dimensional array of photosensitive cells, which will be sometimes referred to herein as “pixels”. Each of those photosensitive cells receives the incoming light at both of the first and second surfaces 7a and 7b. On at least one of the first and second surfaces 7a and 7b, a dispersive element array 100 is arranged so as to face the photosensitive cell array. In the example illustrated in FIG. 1, the dispersive element array 100 is arranged on the same side as only the first surface 7a. However, the dispersive element array 100 may also be arranged on the same side as only the second surface 7b or even two dispersive element arrays may be arranged on the same side as the first and second surfaces 7a and 7b, respectively. The optical system 20 is designed to split the incoming light into first and second light rays and make those rays respectively strike the first and second surfaces 7a and 7b of the semiconductor layer 7.

According to the present invention, the dispersive element array 100 makes two light rays falling within mutually different wavelength ranges incident on first and second photosensitive cells, respectively, which are both included in the photosensitive cell array. That is why by making computations on photoelectrically converted signals supplied from those two photosensitive cells, color information can be obtained.

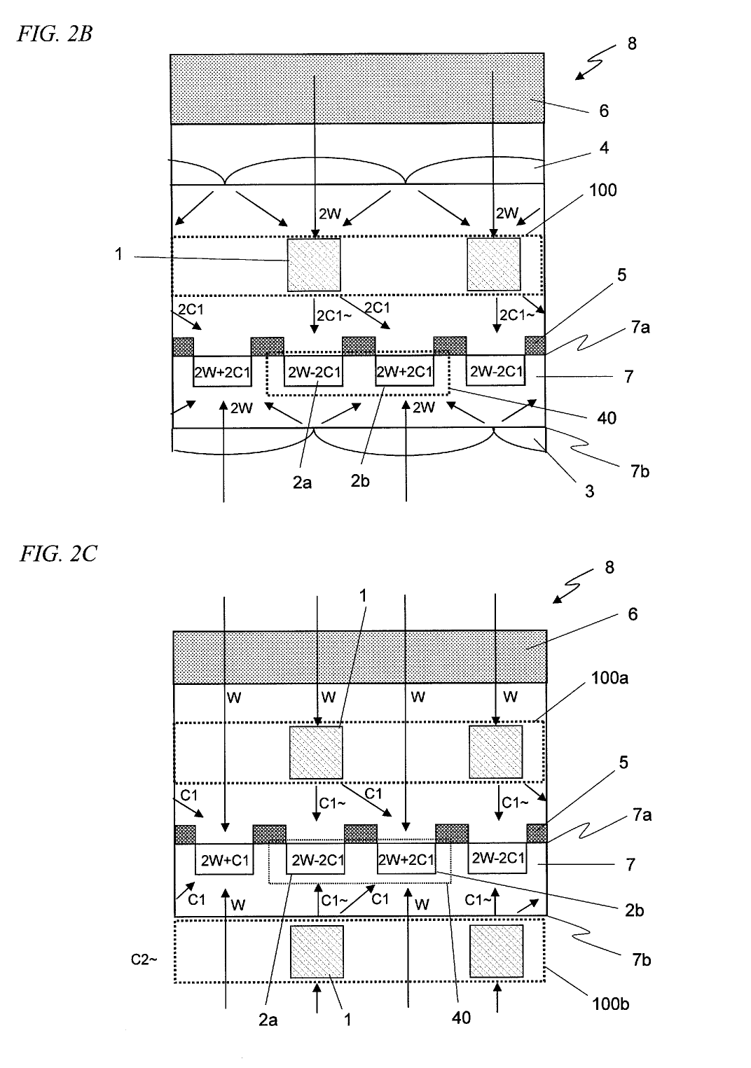

FIG. 2A is a cross-sectional view schematically illustrating an exemplary internal structure for the image sensor 8. In this example, an interconnect layer 5 is arranged on the same side as the first surface 7a of the semiconductor layer 7. The photosensitive cell array has a number of unit blocks 40, each of which includes photosensitive cells 2a and 2b. In this example, the dispersive element array 100 consisting of a number of dispersive elements 1 is arranged on the same side as the first surface 7a when viewed from the photosensitive cell array. Also, a transparent substrate 6 is arranged on the other side of the dispersive element array 100 opposite to the photosensitive cell array. The transparent substrate 6 supports the semiconductor layer 7, the dispersive element array 100 and other structures. With such an arrangement, each of those photosensitive cells 2a and 2b can receive not only the light that has been transmitted through the transparent substrate 6 and the dispersive element array 100 and then incident on the semiconductor layer 7 at the first surface 7a but also the light that has been incident on the semiconductor layer 7 at the second surface 7b.

Each of the photosensitive cells that are arranged in the semiconductor layer 7 receives the incoming light that has come through both of the first and second surfaces 7a and 7b and outputs an electrical signal (which will be referred to herein as either a “photoelectrically converted signal” or a “pixel signal”) representing the quantity of the light received. According to the present invention, each element is arranged so that the image produced by a first light ray on the plane on which the photosensitive cells are arranged and the image produced by a second light ray there exactly match to each other.

Hereinafter, it will be described what photoelectrically converted signals are generated in the example illustrated in FIG. 2A.

First of all, two visible radiations (incoming light rays) that have the same intensity and the same spectral distribution are supposed to be incident on the image sensor 8 from over its upper surface and from under its lower surface, respectively. Those visible radiations will be identified herein by W. However, the incoming visible radiations do not have to be white light rays but may be any of various color rays according to the subject. In this description, each visible radiation W is supposed to be split into three color components C1, C2 and C3, which are typically, but do not always have to be, red (R), green (G) and blue (B) components.

In the example illustrated in FIG. 2A, the dispersive element 1 faces the photosensitive cell 2a and splits the incoming light (which will be referred to herein as “W light”) into a C1 ray and a C1˜ ray that falls within the wavelength range of the complementary color of that of the C1 ray. Then, the C1 ray is incident on the photosensitive cell 2b and the C1˜ ray is incident on the photosensitive cell 2a. In this case, since the C1˜ ray is a combination of C2 and C3 rays, C1˜ will sometimes be replaced herein by C2+C3. Also, since the C1˜ ray is obtained by subtracting the C1 ray from the W light, C1˜ will also be replaced herein by W−C1. Each of the other color component rays will also be represented herein by such alternative expressions in the same way.

In such an arrangement, the photosensitive cell 2a receives not only the C1˜ ray that has come through the dispersive element 1 from over the first surface 7a but also the W light that has come from under the second surface 7b. On the other hand, the photosensitive cell 2b receives not only the C1 ray that has come through the dispersive element 1 from over the first surface 7a but also the two incoming light beams (2W) that have come directly through the first and second surfaces 7a and 7b without passing through the dispersive element 1. As used herein, the reference sign “2W” indicates that the overall quantity of those two light beams is twice as large as the W light beam that has come through only one surface.

If the photoelectrically converted signals supplied from the photosensitive cells 2a and 2b are identified by S2a and S2b and if signals representing the intensities of the W light and the C1, C2 and C3 rays are identified by Ws, C1s, C2s, and C3s, respectively, then S2a and S2b are represented by the following Equations (1) and (2), respectively:

S2a=2Ws−C1s=C1s+2C2s+2C3s (1)

S2b=2Ws+C1s=3C1s+2C1s+2C3s (2)

By subtracting S2a from S2b, the following Equation (3) can be obtained:

S2b−S2a=2C1s (3)

That is to say, by performing signal arithmetic operations on two pixels, the C1s signal representing the intensity of the color component C1 can be calculated.

And by performing the same signal arithmetic operations on each of the other unit blocks 40 repeatedly, the pixel-by-pixel intensity distribution of the color component C1 can be obtained. In other words, an image representing that color component C1 can be obtained through the signal arithmetic operations.

As for the other color components C2 and C3, their associated color signals can also be obtained in the same way. For example, if a dispersive element for splitting the incoming light into a C2 ray and a C2˜ (=W−C2l ) ray falling within the wavelength range of its complementary color is arranged on a row that is adjacent to the row with the dispersive element 1 and if one unit block is made up of four pixels, a signal C2s representing the intensity of the C2 ray can also be obtained by performing similar signal arithmetic operations. As can be seen from Equations (1) and (2), if S2a and S2b are added together, the sum is 4Ws. That is why by calculating Ws−C1s−C2s, the signal C3s representing the intensity of the C3 ray can also be obtained. That is to say, by performing such signal arithmetic operations on four pixels, three color signals can be obtained, and therefore, a color image can be generated.

The basic structure of the image sensor of this preferred embodiment does not have to be as illustrated in FIG. 2A but may be any of various other ones. Hereinafter, a couple of those alternative basic structures for an image sensor that can also be adopted in the present invention will be described.

FIG. 2B illustrates an example in which two arrays of micro lenses are provided for the photosensitive cell array. Specifically, in this example, a micro lens 4 is arranged on the same side as the first surface 7a so as to face the photosensitive cell 2a, and another micro lens 3 is arranged on the same side as the second surface 7b so as to face the photosensitive cell 2b. These micro lenses 4 and 3 are arranged so as to condense the light that is going to enter two pixel regions onto a single pixel. That is why the quantity of the light entering the dispersive element 1 is doubled compared to a situation where the arrangement shown in FIG. 2A is adopted. And therefore, the quantities of the split C1 and C1˜ rays are also twice as large as those of the C1 and C 1˜ rays in the arrangement shown in FIG. 2A. Likewise, the quantity of the light entering the photosensitive cell 2b through the second surface 7b is also doubled compared to a situation where the arrangement shown in FIG. 2A is adopted.

In such an arrangement, the photoelectrically converted signals S2a and S2b supplied from the photosensitive cells 2a and 2b are represented by the following Equations (4) and (5), respectively:

S2a=2Ws−2C1s (4)

S2b=2Ws+2C1s (5)

Consequently, the signal C1s representing the intensity of the color component C1 can also be obtained in this example simply by calculating the difference between two pixels.

In the examples described above, the dispersive element array 100 is supposed to be arranged only on the same side as the first surface 7a with respect to the photosensitive cell array. However, the dispersive element array 100 may also be arranged only on the same side as the second surface 7b or may even be arranged on each of these two sides.

FIG. 2C illustrates an example in which dispersive element arrays are arranged on both sides of the photosensitive cell array. As shown in FIG. 2C, a first dispersive element array 100a is arranged on the same side as the first surface 7a so as to face the photosensitive cell array, and a second dispersive element array 100b is arranged on the same side as the second surface 7b. In this example, each of the first and second dispersive element arrays 100a and 100b includes a dispersive element 1 that faces the photosensitive cell 2a. Each of these two dispersive elements 1 that are arranged on both sides of the photosensitive cell 2a makes a C1 ray and a C1˜ ray incident on the photosensitive cells 2b and 2a, respectively. As a result, the photosensitive cell 2a receives two C1˜ rays (2Cl˜=2W−2C1) from the two dispersive elements 1, while the photosensitive cell 2b receives two C1 rays (2Cl) from the two dispersive elements 1 and two light beams (2W) that have been directly incident there from both sides and without passing through any dispersive element 1.

In such an arrangement, the photoelectrically converted signals S2a and S2b supplied from the photosensitive cells 2a and 2b are also calculated by Equations (4) and (5), respectively, as in the arrangement shown in FIG. 2B. That is why even when the arrangement shown in FIG. 2C is adopted, color information can also be obtained by performing the signal arithmetic operations described above.

As described above, the image sensor 8 of this preferred embodiment can generate color information by using dispersive elements instead of color filters that absorb light, and therefore, the optical efficiency can be increased. In addition, the image sensor 8 of the present invention receives the incoming light at both of its front and back surfaces, thus increasing the flexibility of the manufacturing process compared to conventional image sensors that receive light on only one side. Specifically, structures such as the dispersive element array can be arranged on both sides, not on one side, and therefore, the density of dispersive elements to be arranged on each of the two sides can be reduced.

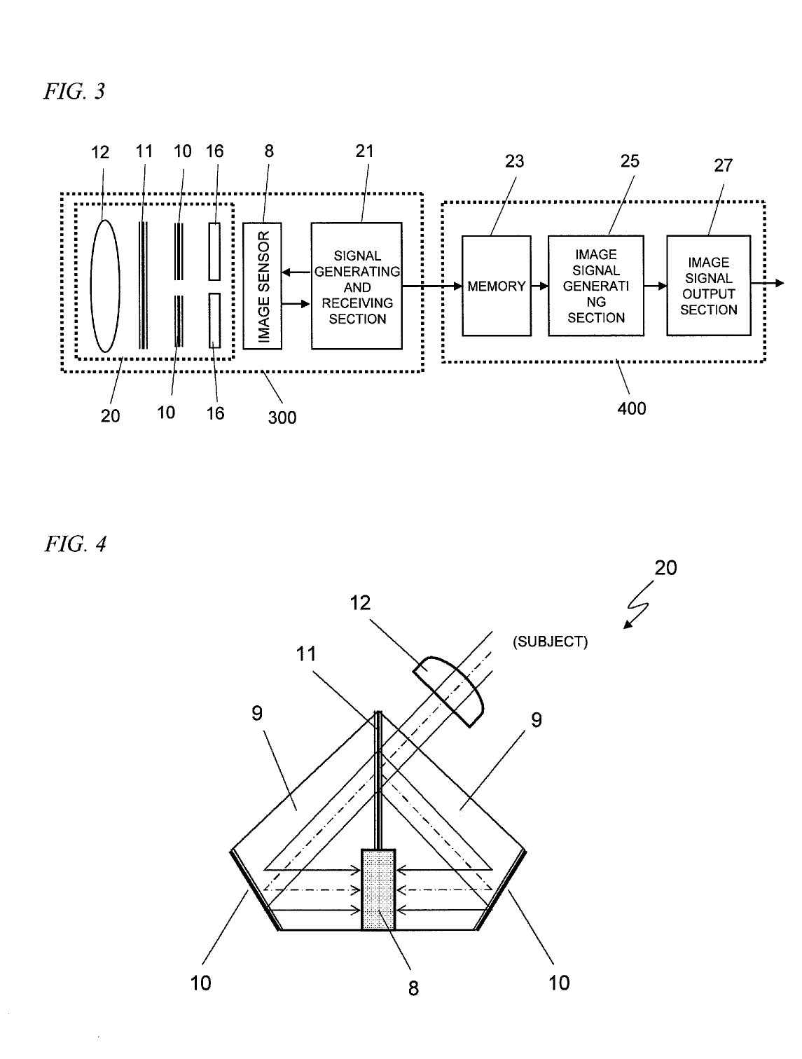

Hereinafter, preferred embodiments of the present invention will be described with reference to FIGS. 3 through 6C. In the following description, any pair of components shown in multiple drawings and having substantially the same function will be identified by the same reference numeral.

### Embodiment 1

First, a First Specific Preferred Embodiment of the present invention will be described. FIG. 3 is a block diagram illustrating an overall configuration for an image capture device as a first preferred embodiment of the present invention. The image capture device of this preferred embodiment is a digital electronic camera and includes an image capturing section 300 and a signal processing section 400 that receives a signal from the image capturing section 300 and outputs a signal representing an image (i.e., an image signal). The image capture device may either generate only a still picture or have the function of generating a moving picture.

The image capturing section 300 includes an optical system 20 for imaging a given subject, a solid-state image sensor 8 (which will be simply referred to herein as an “image sensor”) for converting optical information into an electrical signal by photoelectric conversion, and a signal generating and receiving section 21, which not only generates a fundamental signal to drive the image sensor 8 but also receives the output signal of the image sensor 8 and sends it to the signal processing section 400. The optical system 200 includes an optical lens 12, a half mirror 11, two reflective mirrors 10 and two optical filters 16. In this case, the optical lens 12 is a known lens and may be a lens unit including multiple lenses. The optical filters 16 are a combination of a quartz crystal low-pass filter for reducing a moiré pattern to be caused by a pixel arrangement with an infrared cut filter for filtering out infrared rays. The image sensor 8 is typically a CMOS or a CCD, may be fabricated by known semiconductor device processing technologies, and is electrically connected to a processing section (not shown) including a driver and a signal processor. The signal generating and receiving section 21 may be implemented as an LSI such as a CCD driver.

The signal processing section 400 includes an image signal generating section 25 for generating an image signal by processing the signal supplied from the image capturing section 300, a memory 23 for storing various kinds of data that have been produced while the image signal is being generated, and an image signal output section 27 for sending out the image signal thus generated to an external device. The image signal generating section 25 is preferably a combination of a hardware component such as a known digital signal processor (DSP) and a software program for use to perform image processing involving the image signal generation. The memory 23 may be a DRAM, for example. And the memory 23 not only stores the signal supplied from the image capturing section 300 but also temporarily retains the image data that has been generated by the image signal generating section 25 or compressed image data. These image data are then output to either a storage medium or a display section (neither is shown) by way of the image signal output section 27.

The image capture device of this preferred embodiment actually further includes an electronic shutter, a viewfinder, a power supply (or battery), a flashlight and other known components. However, the description thereof will be omitted herein because none of them are essential components that would make it difficult to understand how the present invention works unless they were described in detail. It should also be noted that this configuration is just an example. Rather, the present invention may also be carried out as any other appropriate combination of known elements as long as the image sensor 8 and the image signal generating section 25 are included.

Hereinafter, an arrangement for the optical system 20 of this preferred embodiment will be described.

FIG. 4 schematically illustrates an arrangement for the optical system 20 of this preferred embodiment. The optical system 20 includes a lens 12 for condensing the light that has come from the subject, a half mirror 11 for splitting the light that has been transmitted through the lens 12 into a transmitted light ray and a reflected light ray, and two reflective mirrors 10 for respectively reflecting those two split light rays that have come from the half mirror 11. Optionally, the optical system 20 may further include additional components such as the optical filter 16 mentioned above. However, illustration of those additional components other than the lens 12, the half mirror 11 and the reflective mirrors 10 is omitted in FIG. 4. In any case, the respective components of the optical system 20 are arranged so that the light rays that have been reflected from the two reflective mirrors 10 are imaged by the image sensor 8 on both sides thereof. In this case, the image sensor 8 has a transparent substrate that supports the semiconductor layer and can receive the incoming light both at one surface thereof with the interconnect layer (i.e., its front surface) and at the other surface thereof with no interconnect layers (i.e., its back surface). The optical system 20 and the image sensor 8 are housed and retained in a transparent package 9, which is obtained by joining two transparent containers together. Although the lens 12 is illustrated as a single lens in FIG. 4 for the sake of simplicity, the lens 12 ordinarily includes a number of lenses that are arranged in the optical axis direction. Likewise, the optical system 20 does not have to be the one shown in FIG. 4, either, but may also have any other arrangement as long as the optical system 20 allows the image sensor 8 to image the incoming light on both sides thereof.

Next, the image sensor 8 of this preferred embodiment will be described.

The image sensor 8 of this preferred embodiment has a semiconductor layer that has upper and lower surfaces, between which a photosensitive cell array, including a two-dimensional arrangement of photosensitive cells (or pixels), has been formed. Each of the two light rays that have been reflected from the reflective mirrors 10 is incident on the photosensitive cell array through either the upper surface or the lower surface. Each of those photosensitive cells is typically a photodiode, which generates a photoelectrically converted signal (which will also be referred to herein as a “pixel signal”), representing the quantity of the light received, by photoelectric conversion and outputs it.

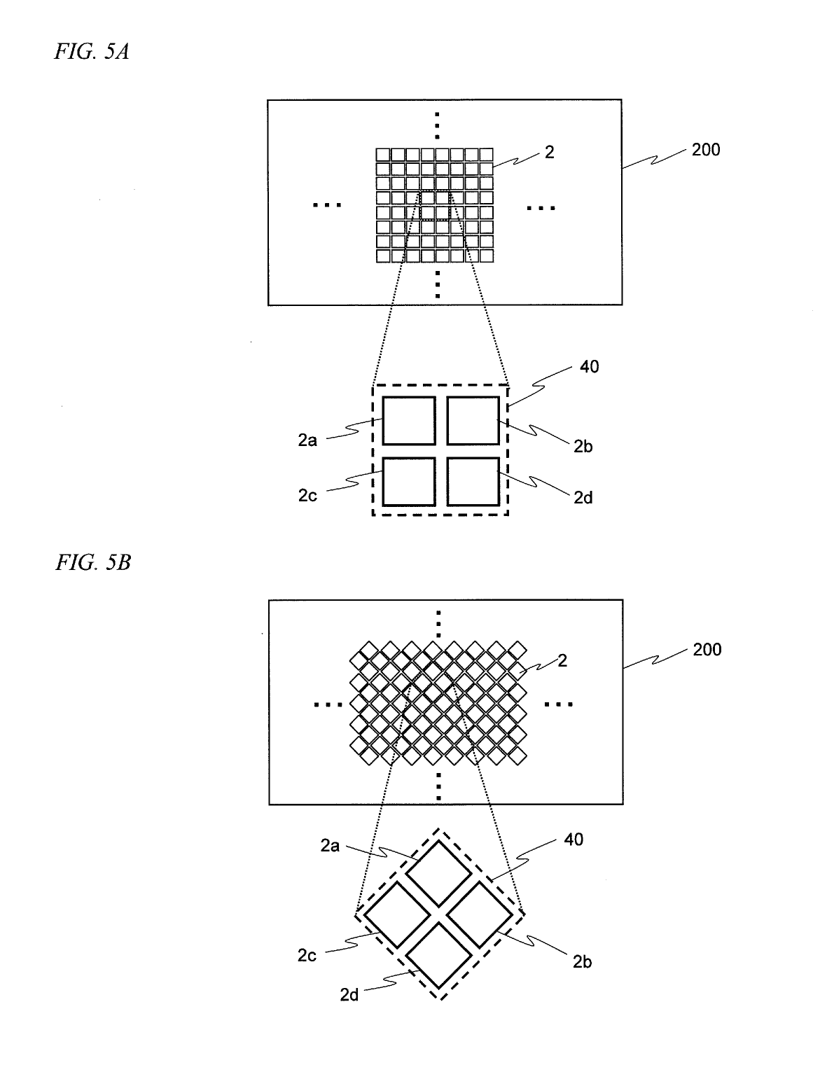

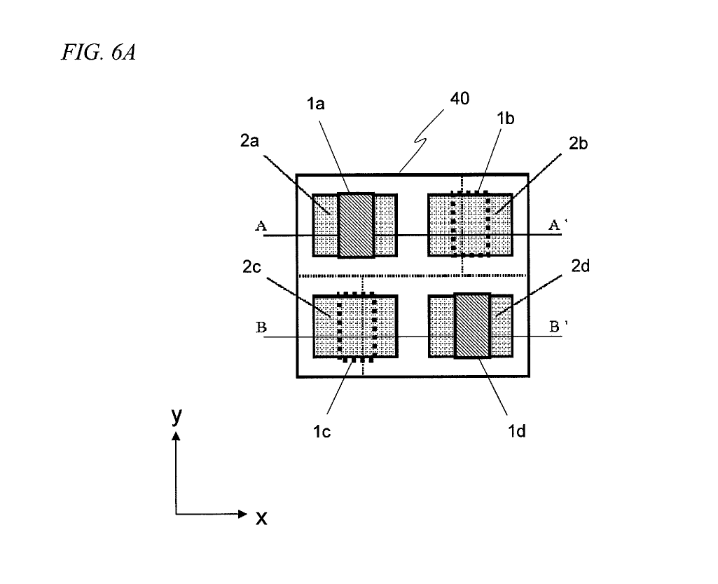

FIG. 5A is a plan view illustrating an exemplary arrangement of pixels according to this preferred embodiment. The photosensitive cell array 200 may include a number of photosensitive cells 2, which are arranged to form a tetragonal lattice on the imaging area as shown in FIG. 5A. The photosensitive cell array 200 consists of multiple unit blocks 40, each of which includes four photosensitive cells 2a, 2b, 2c and 2d. It should be noted that the photosensitive cells do not always have to be arranged in such a tetragonal lattice but could also be arranged to form an oblique lattice such as the one shown in FIG. 5B or any other arbitrary pattern. Furthermore, it is preferred that the four photosensitive cells 2a to 2d included in each unit block be arranged close to each other as shown in FIGS. 5A and 5B. However, even if those photosensitive cells 2a to 2d were well spaced from each other, color information could still be obtained by forming appropriately the dispersive element array to be described later. If necessary, each unit block may even have five or more photosensitive cells as well.

In this preferred embodiment, an array of dispersive elements is arranged on each of the front and back surface sides so as to face the photosensitive cell array 200. Hereinafter, the dispersive elements of this preferred embodiment will be described.

The dispersive element of this preferred embodiment is an optical element for refracting incoming light to multiple different directions according to the wavelength range by utilizing diffraction of the light to produce on the boundary between two different light transmissive members with mutually different refractive indices. The dispersive element of that type includes high-refractive-index transparent portions (core portions), which are made of a material with a relatively high refractive index, and low refractive-index transparent portions (clad portions), which are made of a material with a relatively low refractive index and which contact with side surfaces of the core portions. Since the core portion and the clad portion have mutually different refractive indices, a phase difference is caused between the light rays that have been transmitted through the core and clad portions, thus producing diffraction. And since the magnitude of the phase difference varies according to the wavelength of the light, the incoming light can be spatially separated according to the wavelength range into multiple light rays representing respective color components. For example, a light ray representing a first color component can be refracted toward a first direction and a light ray representing a color component other than the first color component can be refracted toward a second direction. Alternatively, one and the other halves of the light representing the first color component may be refracted towards the first and second directions, respectively, and a light ray representing a different color component other than the first one may be refracted toward a third direction as well. Still alternatively, three light rays representing mutually different color components could be refracted toward three different directions, too. Since the incoming light can be split due to the difference in refractive index between the core and clad portions, the high-refractive-index transparent portion will sometimes be referred to herein as a “dispersive element”. Such diffractive dispersive elements are disclosed in Japanese Patent Publication No. 4264465, for example.

A dispersive element array, including such dispersive elements, may be fabricated by performing thin-film deposition and patterning processes by known semiconductor device processing technologies. By appropriately determining the material (and refractive index), shape, size and arrangement pattern of the dispersive elements, multiple light rays falling within intended wavelength ranges can be made to be incident on respective photosensitive cells either separately from each other or combined together. As a result, signals representing required color components can be calculated based on a set of photoelectrically converted signals supplied from the respective photosensitive cells.

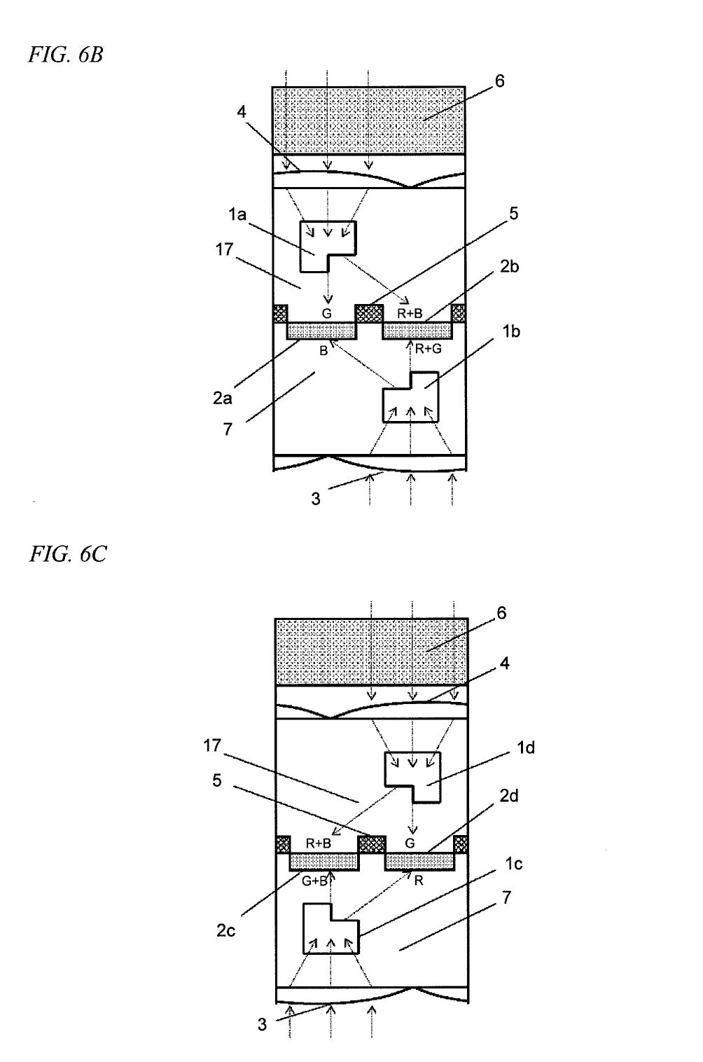

Hereinafter, it will be described with reference to FIGS. 6A through 6C what the basic structure of the image sensor 8 of this preferred embodiment is like and how the dispersive elements work.

FIG. 6A is a plan view illustrating the basic structure of the image sensor 8 as viewed from over the front surface thereof. In this preferred embodiment, a matrix of pixels that are arranged in two columns and two rows is used as a fundamental unit of signal processing. Specifically, two dispersive elements 1a and 1d are arranged on the same side as the front surface so as to face the photosensitive cells 2a and 2d, respectively, while two more dispersive elements 1b and 1c are arranged on the same side as the back surface so as to face the photosensitive cells 2b and 2c, respectively. A number of basic structures, each having the same arrangement pattern like this, are arranged both vertically and horizontally over the entire imaging area of the image sensor 8. In the following description, the x and y coordinates shown in the drawings will be used to indicate directions. Specifically, the x-axis direction will be referred to herein as “horizontal direction” and the y-axis direction will be referred to herein as “vertical direction”.

FIGS. 6B and 6C are cross-sectional views of the image sensor 8 shown in FIG. 6A as viewed on the planes A-A′ and B-B′, respectively. The image sensor 8 includes: a semiconductor layer 7 made of silicon or any other suitable material; photosensitive cells 2a through 2d, which are arranged in the semiconductor layer 7; an interconnect layer 5 and a transparent layer 17 of a low-refractive-index transparent material, which have been stacked in this order on the front surface of the semiconductor layer 7; dispersive elements 1a and 1d, which are made of a high-refractive-index transparent material and arranged in the transparent layer 17; and dispersive elements 1b and 1c, which are arranged in the semiconductor layer 7. In this case, the dispersive elements 1a and 1d have the same property. Also, micro lenses 4 that condense the incoming light toward the dispersive elements 1a and 1d, respectively, are arranged on the same side as the front surface of the semiconductor layer with the transparent layer 17 interposed between them. Likewise, micro lenses 3 that condense the incoming light toward the dispersive elements 1b and 1c, respectively, are arranged on the same side as the back surface of the semiconductor layer 7. And on the same side as the front surface of the semiconductor layer 7, arranged is a transparent substrate 6 to support the semiconductor layer 7, the interconnect layer 5 and other members thereon. The transparent substrate 6 is bonded to the semiconductor layer 7 with the transparent layer 17 interposed between them.

The structure shown in FIGS. 6B and 6C can be fabricated by known semiconductor device processing. To form such a structure, the following process may be carried out, for example. First of all, an array of photosensitive cells and dispersive elements 1b and 1c are formed in a surface region of a semiconductor substrate with a certain thickness, and then an interconnect layer 5, dispersive elements 1a and 1d, micro lenses 4 and other members are formed on the front surface of the substrate. Subsequently, the semiconductor substrate and a transparent substrate are bonded together with a transparent layer 17 interposed between them. Thereafter, the back surface side of the semiconductor substrate is polished or etched to have its thickness reduced to several micrometers, for example, thereby forming a semiconductor layer 7. After the semiconductor layer 7 has been formed, micro lenses 3 and other members are arranged on the back surface side. In this process step, the dispersive elements 1b and 1c and the micro lenses 3 on the back surface side are aligned with their counterparts on the front surface side so that when incoming light strikes both sides of this structure, two images produced on the array of photosensitive cells will exactly match to each other.

The dispersive elements 1a and 1b shown in FIG. 6B are made of a transparent material that has a higher refractive index than the transparent layer 17 and the semiconductor layer 7 and have a step at their light-outgoing end. And by taking advantage of a difference in refractive index from either the transparent layer 17 or the semiconductor layer 7, the dispersive elements 1a and 1b split the incoming light into diffracted rays of various orders including zero-order, first-order, and minus-first-order ones. As the angle of diffraction of each of these rays varies with the wavelength, each dispersive element can split the incoming light into two light rays going in two different directions according to the color component. Specifically, the dispersive element 1a makes a green ray (G) incident on the photosensitive cell 2a that is located right under itself (i.e., that faces it) and also makes a light ray (R+B), falling within the magenta ray wavelength range, incident on its adjacent photosensitive cell 2b. On the other hand, the dispersive element 1b makes a light ray (R+G), falling within the yellow ray wavelength range, incident on the photosensitive cell 2b that is located right under itself (i.e., that faces it) and also makes a blue ray (B) incident on its adjacent photosensitive cell 2a. Each of the micro lenses 3 and 4 condenses incoming light onto two horizontal pixels by one vertical pixel. And those micro lenses 3 and 4 are arranged so as to be horizontally shifted from each other by one pixel pitch.

The dispersive elements 1c and 1d shown in FIG. 6C are also made of a transparent material that has a higher refractive index than the transparent layer 17 and the semiconductor layer 7 and have a step at their light-outgoing end. The dispersive element 1d, which is arranged on the front surface side so as to face the photosensitive cell 2d, is horizontally shifted by one pixel with respect to the dispersive element 1a. The dispersive element 1c, which is arranged on the back surface side so as to face the photosensitive cell 2c, makes a light ray (G+B), falling within the cyan ray wavelength range, incident on the photosensitive cell 2c that is located right under itself (i.e., that faces it) and also makes a red ray (R) incident on its adjacent photosensitive cell 2d. On the other hand, just like the dispersive element 1a, the dispersive element 1d makes a green ray (G) incident on the photosensitive cell 2d that faces it and also makes a light ray (R+G), falling within the magenta ray wavelength range, incident on its adjacent photosensitive cell 2c. The micro lens 3 is arranged on the back surface side to face the dispersive element 2c, while the micro lens 4 is arranged on the front surface side to face the dispersive element 2d.

As described above, according to this preferred embodiment, not all of the dispersive elements are arranged on one side of the imaging area of the image sensor but they are arranged on both sides of the image sensor separately. And by getting color separation done by such a split arrangement, the density of the dispersive elements arranged can be approximately halved compared to the conventional arrangement. As a result, when a color image sensor is fabricated, patterning and other processes should be done with higher accuracy.

In the arrangement described above, the incoming light is split by the imaging optical system 20 into two light rays, which respectively strike the front and back surfaces of the image sensor 8. Since the transparent substrate 6 transmits the light, the respective photosensitive cells 2a through 2d of the image sensor 8 receive the light rays that have come through the front and backs surfaces. Although the quantity of the light falling on one of the two imaging areas is halved by a half mirror, the quantity of light that strike each of those dispersive elements 1a through 1d is the same as that of the light incident on a single pixel in a situation where no half mirrors are provided, because the size of one micro lens corresponds to the combined size of two pixels. Hereinafter, the quantity of light received by each photosensitive cell will be described.

First, the light received by the photosensitive cells 2a and 2b will be described. Specifically, the light that has come through the front surface of the image sensor 8 is transmitted through the transparent substrate 6 and the micro lens 4, and split by the dispersive element 1a into a green (G) ray and non-green (R+B) rays, which are then incident on the photosensitive cells 2a and 2b, respectively. On the other hand, the light that has come through the back surface of the image sensor 8 is transmitted through the micro lens 3, and split by the dispersive element 1b into a blue (B) ray and non-blue (R+G) rays, which are then incident on the photosensitive cells 2a and 2b, respectively.

Next, the light received by the photosensitive cells 2c and 2d will be described. Specifically, the light that has come through the front surface of the image sensor 8 is transmitted through the transparent substrate 6 and the micro lens 4, and split by the dispersive element 1d into non-green (R+B) rays and a green (G) ray, which are then incident on the photosensitive cells 2c and 2d, respectively. On the other hand, the light that has come through the back surface of the image sensor 8 is transmitted through the micro lens 3, and split by the dispersive element 1c into non-red (G+B) rays and a red (R) ray and, which are then incident on the photosensitive cells 2c and 2d, respectively.

Supposing signals representing the intensities of incoming light (visible radiation), a red ray, a green ray and a blue ray are identified by Ws, Rs, Gs and Bs, respectively, the photoelectrically converted signals S2a, S2b, S2c and S2d, which are the output signals of the photosensitive cells 2a through 2d, are represented by the following Equations (6) through (9):

S2a=Ws−Rs=Gs+Bs (6)

S2b=Ws+Rs=2Rs+Gs+Bs (7)

S2c=Ws+Bs=Rs+Gs+2Bs (8)

S2d=Ws−Bs=Rs+Gs (9)

By making additions and subtractions based on these Equations (6) through (9), the following Equations (10) through (13) are obtained:

S2b−S2a=2Rs (10)

S2a+S2b=2Rs+2Gs+2Bs=2Ws (11)

S2c−S2d=2Bs (12)

S2c+S2d=2Rs+2Gs+2Bs=2Ws (13)

The image signal generating section 25 (see FIG. 3) performs the arithmetic operations represented by Equations (10) through (13) on the photoelectrically converted signals represented by Equations (6) through (9), thereby generating color information. In this manner, R and B signals are obtained by performing signal subtractions between the photosensitive cells in the horizontal direction (i.e., in the x direction) and a W signal is obtained by performing signal additions between the photosensitive cells in the horizontal direction. Furthermore, by subtracting R and B signals from the W signal, a G signal can be obtained. Consequently, a color signal consisting of the R, G and B signals can be obtained through these signal arithmetic operations.

The image signal generating section 25 performs these signal arithmetic operations on each unit block 40 of the photosensitive cell array 200, thereby generating signals representing R, G and B color image components (which will be referred to herein as “color image signals”). The color image signals thus generated are output by the image signal output section 16 to a storage medium or a display section (not shown).

As described above, the image capture device of this preferred embodiment can get color separation done by performing simple arithmetic operations on the photoelectrically converted signals that are output from the four photosensitive cells. As far as pixel resolution is concerned, one micro lens is provided for every pixel in the vertical direction (i.e., in the y direction), and therefore, decrease in resolution is not a problem. In the horizontal direction (i.e., in the x direction), on the other hand, one micro lens is provided for every two pixels, and therefore, the resolution could decrease. According to this preferred embodiment, however, a so-called “pixel shifted arrangement” in which the micro lenses are arranged so that each micro lens on one row is horizontally shifted by one pixel from associated ones on two adjacent rows is adopted, and therefore, the horizontal resolution would be as high as in a situation where one micro lens is provided for every pixel.

As can be seen from the foregoing description, the image capture device of this preferred embodiment uses dispersive elements that do not absorb light, and therefore, can capture an image with high optical efficiency and high sensitivity. Also, a dispersive element 1a for splitting the incoming light into a green ray (G) and non-green rays (R+B) and a dispersive element 1b for splitting the incoming light into a blue ray (B) and non-blue rays (R+G) are used in combination. Likewise, a dispersive element 1c for splitting the incoming light into a red ray (R) and non-red rays (G+B) and a dispersive element 1d for splitting the incoming light into a green ray (G) and non-green rays (R+B) are used in combination. By using dispersive elements in such combinations, color separation can get done with high sensitivity and an image with a reasonably high resolution can be obtained. On top of that, since dispersive elements are distributed every other pixel both horizontally and vertically on the front surface and back surfaces sides of the image sensor 8, the density of the dispersive elements per side decreases compared to the conventional arrangement. As a result, when the image sensor 8 is fabricated, the dispersive elements can be patterned more accurately, which is beneficial.

It should be noted that the image signal generating section 25 does not always have to generate all of the image signals representing the three color components. Alternatively, the image signal generating section 15 may also be designed to generate image signal(s) representing only one or two colors according to the application. Also, if necessary, the signals may be amplified, synthesized or corrected.

Ideally, each of the dispersive elements has exactly the light-splitting ability described above. But there is no problem even if their light-splitting ability is slightly different from the ideal one. That is to say, the photoelectrically converted signal output from each of the photosensitive cells may be a little different from the signal represented by an associated one of Equation (6) through (9). This is because even if the light-splitting ability of each dispersive element is somewhat different from the ideal one, good color information can still be obtained by correcting the signal according to the magnitude of that difference.

Optionally, the signal arithmetic operations that are performed by the image signal generating section 25 in the preferred embodiment described above may also get done by another device, not the image capture device itself. The color information can also be generated by getting a program defining the signal arithmetic operations of this preferred embodiment executed by an external device that has received the photoelectrically converted signals from the image capture device 8, for example.

The half mirror 11 of the optical system 20 does not have to evenly split the incoming light into two light rays but its transmittance may be different from its reflectance. In that case, the color information can be generated by appropriately modifying the equations according to the intensity ratio between the transmitted and reflected light rays.

The dispersive elements 1a through 1d are supposed to face the photosensitive cells 2a through 2d, respectively, in the foregoing description, but do not always have to face them. Alternatively, each of those dispersive elements may also be arranged to cover two photosensitive cells. Also, in the foregoing description, each of the dispersive elements 1a through 1d splits the incoming light according to the color component by using diffraction. However, the light may also be split by any other means. For example, a known micro prism or dichroic mirror may also be used as the dispersive elements 1a through 1d.

The incoming light does not always have to be split by the respective dispersive elements in the pattern described above. Rather, the color separation can also be done by similar processing as long as a number of dispersive elements are used to split the incoming light into light rays falling within primary color wavelength ranges (which will be referred to herein as “primary color rays”) and light rays falling within their complementary color wavelength ranges (which will be referred to herein as “complementary color rays”) so that each photosensitive cell has its structure designed to receive either two different primary color rays or two different complementary color rays.

Hereinafter, it will be described how color separation can get done by generalizing the color separation processing of the preferred embodiment described above. In the following example, the incoming light (visible radiation) W is supposed to be split into three primary color rays Ci, Cj and Ck, their complementary color rays will be identified herein by (Cj+Ck), (Ci+Ck) and (Ci+Cj), and signals representing the intensities of those primary color rays Ci, Cj and Ck will be identified herein by Cis, Cjs and Cks, respectively.

With such generalization adopted, the respective component may be arranged so that the photosensitive cell 2a receives the Cj and Ck rays through the front surface and back surface, respectively. In that case, the photosensitive cell 2b receives the (Ci+Ck) and (Ci+Cj) rays through the front surface and back surface, respectively. The photosensitive cell 2c receives the (Ci+Ck) and (Cj+Ck) rays through the front surface and back surface, respectively. And the photosensitive cell 2d receives the Cj and Ci rays through the front surface and back surface, respectively.

With such an arrangement, the signals S2a through S2d to be output from the respective photosensitive cells 2a through 2d are represented by the following Equations (14) through (17), respectively:

S2a=Cjs+Cks (14)

S2b=2Cis+Cjs+Cks (15)

S2c=Cis+Cjs+2Cks (16)

S2d=Cis+Cjs (17)

By making additions and subtractions based on these Equations (14) through (17), the following Equations (18) through (21) are obtained:

S2b−S2a=2Cis (18)

S2a+S2b=2Cis+2Cjs+2Cks=2Ws (19)

S2c−S2d=2Cks (20)

S2c+S2d=2Cis+2Cjs+2Cks=2Ws (21)

That is to say, signals Cis and Cks representing the intensities of the Ci and Ck rays are obtained by performing signal subtractions between the photosensitive cells in the horizontal direction and a signal Ws (=Cis+Cjs+Cks) representing the intensity of the W light is obtained by performing signal additions between the photosensitive cells in the horizontal direction. Furthermore, by subtracting Cis and Cks from the Ws signal thus obtained, a signal Cjs representing the Cj ray can be obtained. Consequently, color signals representing the three colors can be obtained. These results reveal that if the arrangement and structure are defined so that a single photosensitive cell receives two different primary color rays and two different complementary color rays, color separation can also get done by performing similar signal arithmetic operations to those of the preferred embodiment described above.

### Embodiment 2

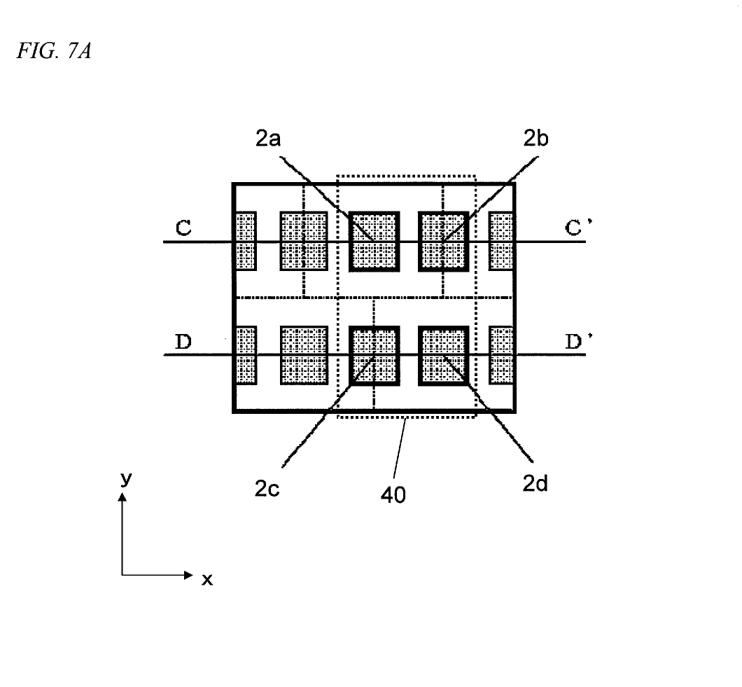

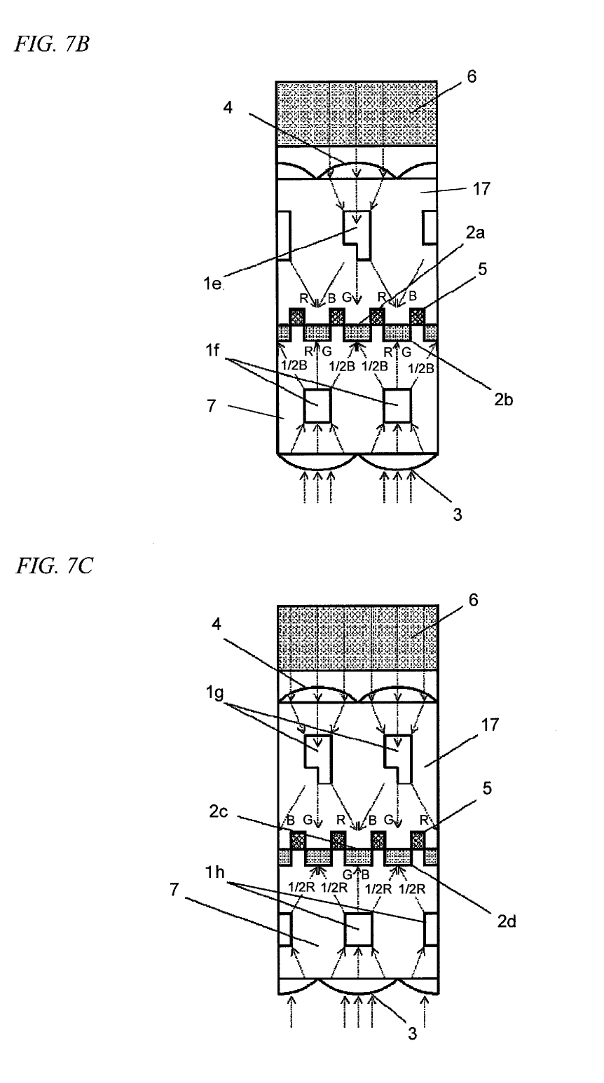

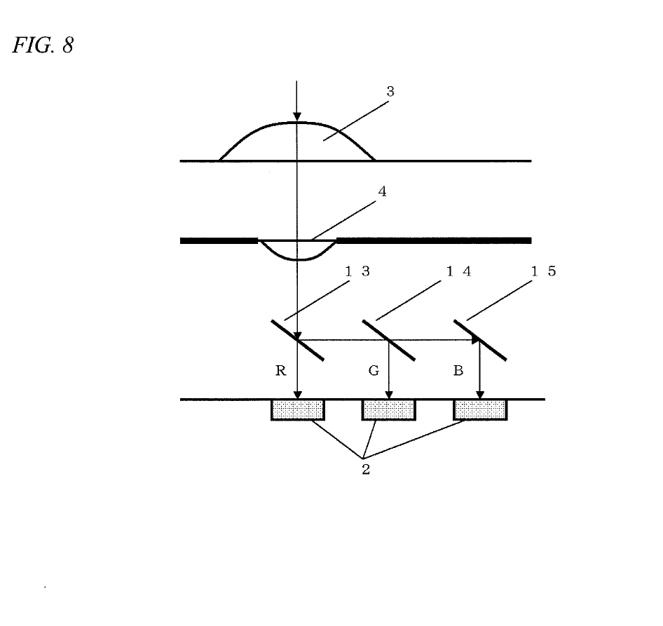

Hereinafter, a second preferred embodiment of the present invention will be described with reference to FIGS. 7A through 7C. The image capture device of this second preferred embodiment has dispersive elements with a different property from the counterparts of the image capture device of the first preferred embodiment described above but the other components of the second preferred embodiment are no different from those of the first preferred embodiment. Thus, the following description of the second preferred embodiment will be focused on only the difference from the image capture device of the first preferred embodiment and the description of their common features will be omitted herein.

FIG. 7A is a plan view illustrating the pixel arrangement of the image sensor 8 of this preferred embodiment as viewed from over the front surface thereof. In this preferred embodiment, a matrix of pixels that are arranged in two columns and two rows is also used as a fundamental unit of signal processing. Specifically, two dispersive elements 1e and 1f are arranged on the front surface side so as to face the photosensitive cells 2a and 2d, respectively, while two more dispersive elements 1g and 1h are arranged on the back surface side so as to face the photosensitive cells 2b and 2c, respectively. In this case, the dispersive elements 1e and 1g have the same property. It should be noted that illustration of the dispersive elements 1e through 1h is omitted in FIG. 7A.

FIG. 7B is a cross-sectional view of the image sensor 8 shown in FIG. 7A as viewed on the plane C-C′. The dispersive elements 1e and 1f are made of a transparent material that has a higher refractive index than the transparent layer 17 and the semiconductor layer 7 and split the incoming light into diffracted rays of various orders including zero-order, first-order, and minus-first-order ones by taking advantage of a difference in refractive index from either the transparent layer 17 or the semiconductor layer 7. As the angle of diffraction of each of these rays varies with the wavelength, each dispersive element can split the incoming light into three light rays going in three different directions according to the color component. In this case, the dispersive element 1e has a step at the light-outgoing end but the dispersive element 1f does not have a step at its end and has a rectangular parallelepiped shape. Specifically, the dispersive element 1e makes a green ray (G) incident on the photosensitive cell 2a that is located right under itself (i.e., that faces it), makes a red ray (R) incident on one (2b) of the two adjacent photosensitive cells 2a, and also makes a blue ray (B) incident on the other adjacent photosensitive cell, which belongs to an adjacent unit block (which will be referred to herein as a “first adjacent unit block”). On the other hand, the dispersive element 1f makes a light ray (R+G), falling within the yellow ray wavelength range, incident on the photosensitive cell 2b that is located right under itself (i.e., that faces it) and also makes one and the other halves of a blue ray (B) incident on the photosensitive cell 2a and on a photosensitive cell in another adjacent unit block (which will be referred to herein as a “second adjacent unit block”). All components of the image capture device of this preferred embodiment but these dispersive elements are the same as their counterparts of the first preferred embodiment described above, and the micro lenses 3 and 4 have the same arrangement and the same size as those of the first preferred embodiment, too.

FIG. 7C is a cross-sectional view of the image sensor 8 shown in FIG. 7A as viewed on the plane D-D′. The dispersive elements 1g and 1h are also made of a transparent material with as high a refractive index as the dispersive elements 1e and 1f and split the incoming light into three light rays going in three different directions according to the color component. Specifically, the dispersive element 1g, which is arranged on the front surface side so as to face the photosensitive cell 2d, has the same property as the dispersive element 1e and is horizontally shifted by one pixel with respect to the dispersive element 1e. The dispersive element 1h is arranged on the back surface side so as to face the photosensitive cell 2c. The dispersive element 1g makes a green ray (G) incident on the photosensitive cell 2d that faces it, makes a blue ray (B) incident on the photosensitive cell 2c and also makes a red ray (R) incident on a photosensitive cell, which belongs to the second adjacent unit block. On the other hand, the dispersive element 1h makes a light ray (G+B), falling within the cyan ray wavelength range, incident on the photosensitive cell 2c that faces it and also makes one and the other halves of a red ray (R) incident on the photosensitive cell 2d and on a photosensitive cell in the first adjacent unit block, respectively. Also, as the dispersive elements 1g and 1h are arranged, the micro lenses 3 and 4 are arranged to face them.

As described above, according to this preferred embodiment, not all of the dispersive elements are arranged on one side of the imaging area of the image sensor but they are arranged on both sides of the image sensor separately. And by getting color separation done by such a split arrangement, the density of the dispersive elements arranged can be approximately halved compared to the conventional arrangement. As a result, when a color image sensor is fabricated, patterning and other processes should be done with higher accuracy.

In the arrangement described above, the incoming light is split by the imaging optical system 20 into two light rays, which respectively strike the front and back surfaces of the image sensor 8 as in the first preferred embodiment described above. Although the quantity of the light falling on one of the two imaging areas is halved by a half mirror, the quantity of light that strike each of those dispersive elements 1e through 1h is the same as that of the light incident on a single pixel in a situation where no half mirrors are provided, because the size of one micro lens corresponds to the combined size of two pixels. Hereinafter, the quantity of light received by each photosensitive cell will be described.

First, the light received by the photosensitive cells 2a and 2b will be described. Specifically, the photosensitive cell 2a receives the green ray (G) that has been transmitted through the dispersive element 1e on the front surface side and also receives two halves of a blue ray (B/2+B/2) that have been transmitted through the two dispersive elements 1f on the back surface side. In this case, one of the two dispersive elements 1f faces a photosensitive cell belonging to the first adjacent unit block. On the other hand, the photosensitive cell 2b receives a red ray (R) that has been transmitted through the dispersive element 1e and a blue ray (B) that has been transmitted through a dispersive element that faces one photosensitive cell belonging to the second adjacent unit block on the front surface side and also receives red and green rays (R+G) that have been transmitted through the dispersive element 1f on the back surface side.

Next, the light received by the photosensitive cells 2c and 2d will be described. Specifically, the photosensitive cell 2c receives a blue ray (B) that has been transmitted through the dispersive element 1g and a red ray (R) that has been transmitted through a dispersive element 1g that faces one photosensitive cell belonging to the first adjacent unit block on the front surface side and also receives green and blue rays (G+B) that have been transmitted through the dispersive element 1h on the back surface side. The photosensitive cell 2d receives the green ray (G) that has been transmitted through the dispersive element 1g on the front surface side and also receives two halves of a red ray (B/2+B/2) that have been transmitted through the two dispersive elements 1h on the back surface side. In this case, one of the two dispersive elements 1h faces a photosensitive cell belonging to the second adjacent unit block.

With such an arrangement, the signals generated by the photosensitive cells 2a through 2d are quite the same as those of the first preferred embodiment described above and are represented by Equations (6) through (9), respectively. As a result, as in the first preferred embodiment described above, color separation can get done by performing simple signal arithmetic operations on four pixels. As far as pixel resolution is concerned, one micro lens is provided for every pixel in the vertical direction, and therefore, decrease in resolution is not a problem. In the horizontal direction, on the other hand, one micro lens is provided for every two pixels, and therefore, the resolution could decrease. According to this preferred embodiment, however, a so-called “pixel shifted arrangement” in which the micro lenses are arranged so that each micro lens on one row is horizontally shifted by one pixel from associated ones on two adjacent rows is adopted, and therefore, the horizontal resolution would be as high as in a situation where one micro lens is provided for every pixel.

As can be seen from the foregoing description, the image capture device of this preferred embodiment uses dispersive elements that do not absorb light, and therefore, can capture an image with high optical efficiency and high sensitivity. Also, according to this preferred embodiment, a dispersive element 1e for splitting the incoming light into the three components of R, G and B and a dispersive element if for splitting the incoming light into a blue ray (B) and non-blue rays (R+G) are used in combination. Likewise, a dispersive element 1h for splitting the incoming light into the three components of R, G and B and a dispersive element 1g for splitting the incoming light into a red ray (G) and non-red rays (G+B) are used in combination. By using dispersive elements in such combinations, color separation can get done with high sensitivity and an image with a reasonably high resolution can be obtained. On top of that, since dispersive elements are distributed every other pixel both horizontally and vertically on the front surface and back surfaces sides of the image sensor 8, the density of the dispersive elements per side decreases compared to the conventional arrangement. As a result, when the image sensor 8 is fabricated, the dispersive elements can be patterned more accurately, which is beneficial.

The dispersive elements 1e through 1h are supposed to face the photosensitive cells 2a through 2d, respectively, in the foregoing description, but do not always have to face them. Alternatively, each of those dispersive elements may also be arranged to cover two photosensitive cells. Also, in the foregoing description, each of the dispersive elements 1e through 1h splits the incoming light according to the color component by using diffraction. However, the light may also be split by any other means. For example, a known micro prism or dichroic mirror may also be used as the dispersive elements 1e through 1h.

According to this preferred embodiment, the incoming light does not always have to be split by the respective dispersive elements in the pattern described above, either. For example, the dispersive elements 1f and 1h may be replaced with the dispersive elements 1b and 1c of the first preferred embodiment, and the dispersive elements 1e and 1g may be replaced with the dispersive elements 1a and 1d of the first preferred embodiment. As long as a dispersive element for splitting the incoming light into R, G and B components and a dispersive element for splitting the incoming light into a primary color and its complementary colors are used in this manner, quite the same effects as those of the preferred embodiment described above are also achieved. According to this preferred embodiment, the color separation can also be done by the same processing, and the same generalization can be adopted, as in the first preferred embodiment described above as long as each photosensitive cell has its structure designed to receive either two different primary color rays or two different complementary color rays.

### INDUSTRIAL APPLICABILITY

The solid-state image sensor and image capture device of the present invention can be used effectively in every camera that uses a solid-state image sensor, and may be used in digital still cameras, digital camcorders and other consumer electronic cameras and in industrial surveillance cameras, to name just a few.

### REFERENCE SIGNS LIST

1, 1a, 1b, 1c, 1d, 1e, 1f, 1g, 1h dispersive element
2, 2a, 2b, 2c, 2d image sensor's photosensitive cell
3, 4 micro lens
5 image sensor's interconnect layer
6 image sensor's transparent substrate
7 image sensor's semiconductor layer
8 image sensor
9 transparent package
10 reflective mirror
11 half mirror
12 lens
13 multilayer color filter that reflects every ray but red (R) ray
14 multilayer color filter that reflects every ray but green (G) ray
15 multilayer color filter that reflects every ray but blue (B) ray
16 optical filter
17 transparent layer
20 optical system
21 signal generating and receiving section
23 memory
25 image signal generating section
27 image signal output section
40 unit element
100 dispersive element array
200 photosensitive cell array
300 image capturing section
400 signal processing section

1. An image capture device comprising
a solid-state image sensor, and
an optical system for producing an image on an imaging area of the solid-state image sensor,
wherein the solid-state image sensor includes:
a semiconductor layer, which has a first surface and a second surface that is opposite to the first surface;
a photosensitive cell array, which has been formed in the semiconductor layer to receive light through both of the first and second surfaces and which has a number of unit blocks, each said block including first and second photosensitive cells; and
at least one dispersive element array, which is arranged on the same side as at least one of the first and second surfaces so as to face the photosensitive cell array and which makes light rays falling within mutually different wavelength ranges incident on the first and second photosensitive cells.

2. The image capture device of claim 1, wherein the optical system makes one and the other halves of the light strike the first and second surfaces, respectively.

3. The image capture device of claim 1, wherein the at least one dispersive element array includes first and second dispersive element arrays, which are arranged on the same side as the first and second surfaces, respectively, so as to face the photosensitive cell array, and
wherein the first dispersive element array makes a light ray falling within a first wavelength range incident on the first photosensitive cell and also makes light rays falling within the other non-first wavelength ranges incident on the second photosensitive cell, and
wherein the second dispersive element array makes a light ray falling within a second wavelength range, which is different from the first wavelength range, incident on the first photosensitive cell and also makes light rays falling within the other non-second wavelength ranges incident on the second photosensitive cell.

4. The image capture device of claim 3, wherein if incoming light is split into three light rays that represent first, second and third color components,
the first dispersive element array includes a first dispersive element, which is arranged in association with the first photosensitive cell to make the light ray representing the first color component incident on the first photosensitive cell and also make both of the two light rays that represent the second and third color components incident on the second photosensitive cell, and
the second dispersive element array includes a second dispersive element, which is arranged in association with the second photosensitive cell to make the light ray representing the second color component incident on the first photosensitive cell and also make both of the two light rays that represent the first and third color components incident on the second photosensitive cell.

5. The image capture device of claim 3, wherein if incoming light is split into three light rays that represent first, second and third color components,
the first dispersive element array includes a first dispersive element, which is arranged in association with the first photosensitive cell to make the three light rays that represent the first, second and third color components incident on the first photosensitive cell, the second photosensitive cell, and one photosensitive cell included in a first adjacent unit block, respectively, and
the second dispersive element array includes a second dispersive element, which is arranged in association with the second photosensitive cell to make one and the other halves of the light ray representing the third color component incident on the first photosensitive cell and on one photosensitive cell included in a second adjacent unit block, respectively, and also make both of the two light rays that represent the first and second color components incident on the second photosensitive cell, and
wherein the first photosensitive cell receives not only the light ray representing the first color component from the first dispersive element but also the light rays representing the third color component from the second dispersive element and from a dispersive element that is arranged in association with a photosensitive cell included in the first adjacent unit block, and
wherein the second photosensitive cell receives the light ray representing the second color component from the first dispersive element, the light ray representing the third color component from a dispersive element that is arranged in association with a photosensitive cell included in the second adjacent unit block, and the light rays representing the first and second color components from the second dispersive element.

6. The image capture device of claim 4, wherein each said unit block further includes third and fourth photosensitive cells, and
wherein the first dispersive element array includes a third dispersive element, which is arranged in association with the third photosensitive cell to make the light ray representing the first color component incident on the third photosensitive cell and also make both of the two light rays that represent the second and third color components incident on the fourth photosensitive cell, and
wherein the second dispersive element array includes a fourth dispersive element, which is arranged in association with the fourth photosensitive cell to make the light ray representing the second color component incident on the third photosensitive cell and also make both of the two light rays that represent the first and third color components incident on the fourth photosensitive cell.

7. The image capture device of claim 5, wherein each said unit block further includes third and fourth photosensitive cells, and
wherein the first dispersive element array includes a third dispersive element, which is arranged in association with the third photosensitive cell to make the three light rays that represent the first, third and second color components incident on the third photosensitive cell, the fourth photosensitive cell, and one photosensitive cell included in the second adjacent unit block, respectively, and
wherein the second dispersive element array includes a fourth dispersive element, which is arranged in association with the fourth photosensitive cell of each said unit block to make one and the other halves of the light ray representing the second color component incident on the third photosensitive cell and on one photosensitive cell included in the first adjacent unit block, respectively, and also make both of the two light rays that represent the first and third color components incident on the fourth photosensitive cell, and
wherein the third photosensitive cell receives not only the light ray representing the first color component from the third dispersive element but also the light rays representing the second color component from the fourth dispersive element and from a dispersive element that is arranged in association with a photosensitive cell included in the second adjacent unit block, and
wherein the fourth photosensitive cell receives the light ray falling within the third wavelength range from the third dispersive element, the light ray falling within the second wavelength range from a dispersive element that is arranged in association with a photosensitive cell included in the first adjacent unit block, and the two light rays falling within the first and third wavelength ranges from the fourth dispersive element.

8. The image capture device of claim 6, wherein the first, second, third and fourth photosensitive cells are arranged in columns and rows, and
wherein the first photosensitive cell is adjacent to the second photosensitive cell, and
wherein the third photosensitive cell is adjacent to the fourth photosensitive cell.

9. The image capture device of claim 6, wherein the solid-state image sensor includes
a first micro lens array, which is arranged to face the first dispersive element array and which includes multiple micro lenses, each of which condenses the incoming light toward the first and third dispersive elements, and
a second micro lens array, which is arranged to face the second dispersive element array and which includes multiple micro lenses, each of which condenses the incoming light toward the second and fourth dispersive elements.

10. The image capture device of claim 1, further comprising a signal processing section, which generates one color signal based on two photoelectrically converted signals supplied from the first and second photosensitive cells.

11. The image capture device of claim 6, further comprising a signal processing section, which generates three color signals based on four photoelectrically converted signals supplied from the first, second, third and fourth photosensitive cells.

12. A solid-state image sensor comprising:
a semiconductor layer, which has a first surface and a second surface that is opposite to the first surface;
a photosensitive cell array, which has been formed in the semiconductor layer to receive light through both of the first and second surfaces and which has a number of unit blocks, each said block including first and second photosensitive cells; and
at least one dispersive element array, which is arranged on the same side as at least one of the first and second surfaces so as to face the photosensitive cell array and which makes light rays falling within mutually different wavelength ranges incident on the first and second photosensitive cells.
